(19) United States
(12) Patent Application Publication
(10) Pub. No.: US 2010/0082324 A1
(43) Pub. Date: Apr. 1, 2010

(54) REPLACING TERMS IN MACHINE TRANSLATION

(75) Inventors: Masaki Itagaki, Redmond, WA (US); Takako Aikawa, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/241,123

(22) Filed: Sep. 30, 2008

(51) Int. Cl. G06F 17/28

(52) U.S. Cl. 704/2

(57) ABSTRACT

A system described herein includes a receiver component that receives an output translation from a machine translation system, wherein the output translation is in a target language and is based at least in part upon an input to the machine translation system in a source language, and wherein the input to the machine translation system includes a first term in the source language and the output translation includes a second term in the target language that corresponds to the first term. The system additionally includes a replacer component in communication with the receiver component that accesses a dictionary of term correspondences, wherein the dictionary of term correspondences includes an indication that the input first term in the source language is desirably translated to a third term in the target language, and wherein the replacer component is configured to automatically replace the second term with the third term to modify the output translation.

### BACKGROUND

Machine translation systems are systems that can be employed to translate text or speech from a source language to a target language, such as from the English language to the Japanese language or vice versa. Thus, if an individual has a document written in a source language that the individual wished to be translated to a target language, the individual can input the document into a machine translation system and the machine translation system can output a translation of the document in the target language.

Typically, machine translation systems use statistical probabilities when translating text or speech from a source language to a target language, as a first term in the source language may have several possible translations in the target language, wherein a correct translation can depend on a context. For instance, the term “save” in the English language can have at least two different meanings depending on context: 1) to rescue; or 2) to retain. Accordingly, if such term were translated into another language, there may be at least two possible translations, wherein a correct translation is dependent upon the context of use of the term. Machine translation systems, however, are typically not trained to be context dependent, and instead output most probable translations without consideration of context. Thus, machine translation systems, particularly when contents of desirably translated text correspond to a specific context, can be associated with relatively poor performance.

### SUMMARY

The following is a brief summary of subject matter that is described in greater detail herein. This summary is not intended to be limiting as to the scope of the claims.

Technologies pertaining to machine translation are described herein. More particularly, post-processing acts pertaining to replacing a portion of an output translation with a defined, desired translation is described herein. A dictionary of term correspondences can include desired translations between terms.

Text or speech can be input to a machine translation system, wherein the text or speech is in the source language and includes the first term. The machine translation system can receive the input text or speech and output a translation in the target language, wherein the output translation includes a second term, and wherein the second term is a translation of the first term by the machine translation system. The library of term correspondences can include an indication that the first term is desirably translated to a third term in the target language. Based upon content of the library of term correspondences, the output translation can be modified by replacing the second term in output of the machine translation system with the third term in the dictionary of term correspondences.

As described in detail herein, the second term in the output translation can be located through use of one or more templates. A template can be, for instance, a portion of a sentence or phrase, wherein the second term in the target language (e.g., in the outpout of the machine translation system) can be placed in a particular position in the template. Translations from the source language to the target language of words and/or phrases in the template (besides the translation from the source language to the target language for the first term) can be known a priori, such that the translation of the first term from the source language to the target language can be determined via inference/deduction. The translation of the first term in the target language through use of the template can be compared with the output of the machine translation system: if the term determined through use of the template matches a term in the output translation, then the located term (e.g., the second term) can be replaced in accordance with contents of the dictionary of term correspondences. If the term determined through use of the template does not match a term in the output translation, another template can be used.

Thus, the dictionary of term correspondences can be used to translate text or speech in view of a particular context without modifying the training or training data of the machine translation system. For instance, the dictionary of term correspondences can pertain to any suitable context, such as automotive, information technology, legal, etc. Furthermore, the dictionary of term correspondences may be user-defined and can be retained on a personal computing device.

Other aspects will be appreciated upon reading and understanding the attached figures and description.

### BRIEF DESCRIPTION OF THE DRAWINGS

FIG. 1 is a functional block diagram of an example system that facilitates modifying a machine translation output for a particular context.

FIG. 2 is a functional block diagram of an example system that facilitates locating a particular term in a translation output by a machine translation system.

FIG. 3 is a functional block diagram of an example system that facilitates locating a particular term in a translation output by a machine translation system.

FIG. 4 is a functional block diagram of an example system that facilitates selecting a library of term correspondences for a certain context.

FIG. 5 is a functional block diagram of an example system that facilitates creating or modifying a library of term correspondences.

FIG. 6 is an example graphical user interface that facilitates translating text from a first natural language to a second natural language.

FIG. 7 is a flow diagram that illustrates an example methodology for modifying a translation output by a machine translation system.

FIG. 8 is a flow diagram that illustrates an example methodology for swapping terms in a translation output by a machine translation system.

FIG. 9 is a flow diagram that illustrates an example methodology for modifying a translation output by a machine translation system.

FIGS. 10 and 11 depict a flow diagram that illustrates an example methodology for modifying a translation output by a machine translation system.

FIG. 12 is an example computing system.

### DETAILED DESCRIPTION

Various technologies pertaining to speech/text translation will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

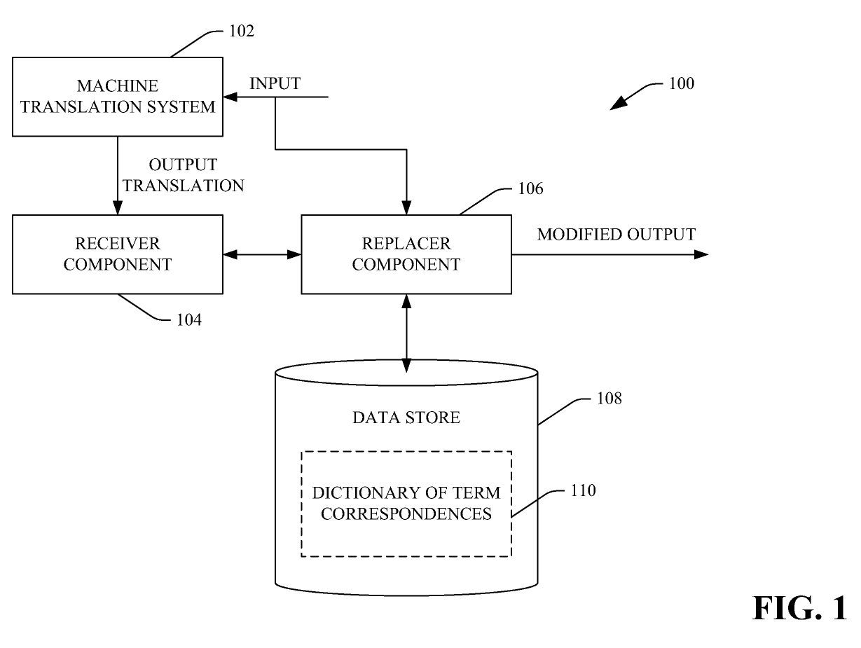

With reference to FIG. 1, an example system 100 that facilitates modifying output of a machine translation system to account for context of input text or speech is illustrated. The system 100 includes a machine translation system 102 that is configured to receive input speech or text and translate such speech or text. The machine translation system 102 can be, for instance, a statistical machine translation system that is trained using any suitable set of training data. In another example, the machine translation system 102 can be a rules-based translation system. The machine translation system 102 can output a translation of the input speech or text. More particularly, the machine translation system 102 can receive speech or text in a source language and can output a translation of the speech or text in a target language. The output translation can include a plurality of terms, sentences, sentence fragments, and/or the like, and the input text or speech can include a plurality of terms, sentences, sentence fragments, and/or the like that correspond to the plurality of terms, sentences, sentence fragments, and/or the like of the output translation. Thus, the translation output by the machine translation system 102 can be based at least in part upon the input received by the machine translation system 102.

A receiver component 104 can be in communication with the machine translation system 102, and can receive the output translation from the machine translation system 102. For instance, the receiver component 104 can be a software module, a hardware module (such as a port), firmware, a suitable combination thereof, etc.

The system 100 can also include a replacer component 106 that is in communication with the receiver component 104. For instance, the replacer component 106 can receive the translation output by the machine translation system 102 from the receiver component 104. In addition, the replacer component 106 can receive the text or speech input to the machine translation system 102 or a portion thereof.

The system 100 also includes a data store 108 that is accessible by the replacer component 106. The data store 108 can be or include memory, a hard drive, etc. A dictionary of term correspondences 110 can be retained in the data store 108, and the replacer component 106 can access the dictionary of term correspondences 110 upon receiving the output translation. The dictionary of term correspondences 110 can include one or more terms in the source language and desired translations for the one or more terms in the target language (the language of the output translation). Contents of the dictionary of term correspondences 110 can be user-defined and/or defined for a particular context. Thus, for instance, if a user wishes to translate text or speech in the context of industrial technology, the dictionary of term correspondences 110 can include terms in the source language that may be found in text pertaining to industrial technology and their desired translations in the target language. Thus, for instance, the dictionary of term correspondences 110 can include the term “save” as well as a corresponding translation in another language that relates to storing data.

In operation, a user can select or define content of the dictionary of term correspondences 110, and can provide the input text or speech in the source language to the machine translation system 102, wherein the input text or speech includes a first term in the source language that is also included in the dictionary of term correspondences 110. The receiver component 104 can receive an output translation from the machine translation system 102, wherein the output translation is in the target language and is based at least in part upon text or speech input to the machine translation system 102 in the source language. The output translation can include a second term in the target language that corresponds to the first term in the source language that was input to the machine translation system 102.

The replacer component 106 can access the dictionary of term correspondences 110, which includes an indication that the input first term in the source language desirably corresponds to (e.g., is desirably translated to) a third term in the target language. The replacer component 106 can be configured to locate the second term in the output translation and replace it with the third term (as indicated in the dictionary of term correspondences 110). Thus, the replacer component 106 can operate subsequent to the machine translation system 102 performing a translation on input text or speech. Locating a term in the output translation (in the target language) that corresponds to a term in the dictionary of term correspondences 110 (in the source language) is described in greater detail below.

The system 100 or portions thereof may be implemented in any suitable computing environment. For instance, the system 100 may be a portion of an application that is configured to be executed on a personal computing device. In another example, the system 100 may be a portion of an application that is executed on a server that is accessible by way of a browser. In still yet another example, the data store 108 may reside on a personal computing device and the replacer component 106 can reside on a server that is accessible by way of a browser. Other configurations are also contemplated and are intended to fall under the scope of the hereto-appended claims.

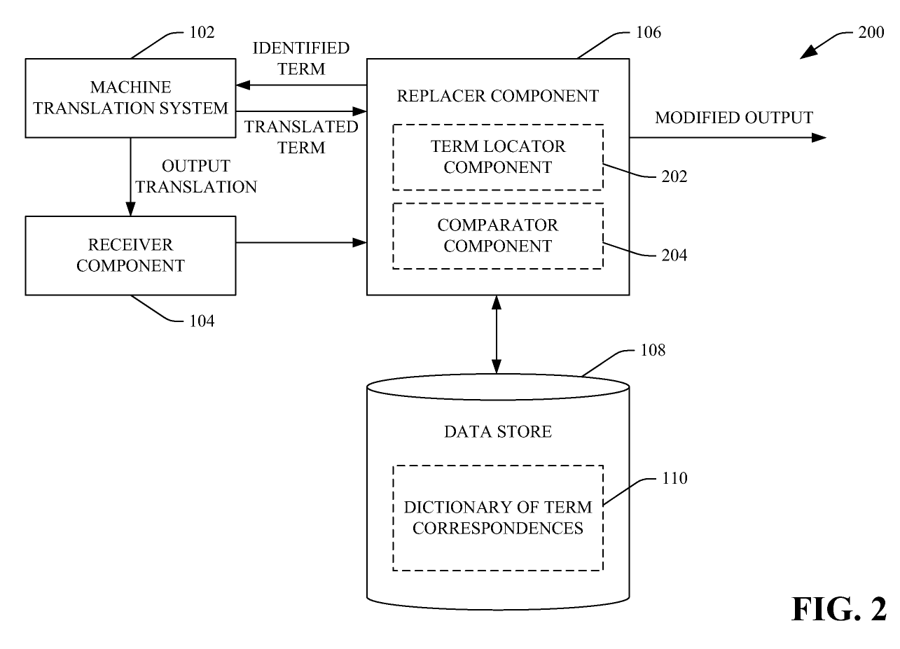

Referring now to FIG. 2, an example system 200 that facilitates replacing a term in an output translation from a machine translation system is illustrated. The system 200 includes the machine translation system 102, which receives input text or speech in a source language and outputs a translation of the input text or speech in a target language. As noted above, the receiver component 104 can receive the output translation, and the replacer component 106 can receive the output translation from the receiver component 104.

The replacer component 106 can comprise a term locator component 202. The term locator component 202 can receive the input text or speech and can access the dictionary of term correspondences 110 in the data store 108. More particularly, the term locator component 202 can compare the input text or speech (in the source language) with terms in the dictionary of term correspondences 110 (e.g., terms in the dictionary of correspondences 110 that are in the source language). If a term in the input text or speech is identified as being included in the dictionary of term correspondences 110, the term locator component 202 can output the identified term (e.g., without other surrounding terms) to the machine translation system 102. The machine translation system 102 can then output a translation for such term. In another example, translations from the machine translation system 102 for terms in the dictionary of term correspondences 110 can be obtained prior to the machine translation system 102 receiving the input text or speech. Translations from the machine translation system 102 for terms in the dictionary of term correspondences 110 can be retained in the data store 108, in another data store, or distributed across several data stores.

The replacer component 106 can additionally include a comparator component 204 that can receive the translated term from the machine translation system 102 and can additionally receive the output translation (that is based on the entirety of the input text or speech in the source language) from the receiver component 104. The translated term and the output translation from the machine translation system 102 can be in the target language. The comparator component 204 can compare the translated term and the output translation, and can locate the translated term in the output translation. The replacer component 106 can thereafter change the output translation by replacing the located term in the output translation with a term that corresponds to the term identified by the term locator component 202 in the dictionary of term correspondences 110.

Pursuant to an example, the dictionary of term correspondences 110 can include an indication that term XXX in the source language desirably corresponds to term YYY in the target language. The input text or speech can include the terms AAA BBB XXX CCC. The machine translation system 102 can output a translation of ZZZ DDD EEE FFF for the input text or speech.

The term locator component 202 can receive the input text or speech, and can determine that the input text or speech includes the term XXX (which, as noted above, is included in the dictionary of term correspondences 110). In an example, the term locator component 202 can provide the identified term XXX (in the source language) to the machine translation system 102, which can output a translation of ZZZ for the identified term XXX. In another example, the machine translation system 102 may have output translations for terms in the dictionary of term correspondences 110 previously, and such translations may be retained in a data store (as described above).

The comparator component 204 can receive the output translation (ZZZ DDD EEE FFF) from the receiver component 104 and/or directly from the machine translation system 102, and can also receive the term (ZZZ) that is a translation of the identified term XXX output by the machine translation system 102 (e.g., a translated term). By comparing the output translation and the translated term, the comparator component 204 can locate the translation of the term XXX in the output translation. In this example, the comparator component 204 can locate the term ZZZ in the output translation of ZZZ DDD EEE FFF. The replacer component 106 can then replace the located term (ZZZ) in the output translation with the term that desirably corresponds to the term XXX (as defined in the dictionary of term correspondences 110). Thus, the replacer component 106 can replace the term ZZZ with the term YYY, such that the modified translation is YYY DDD EEE FFF.

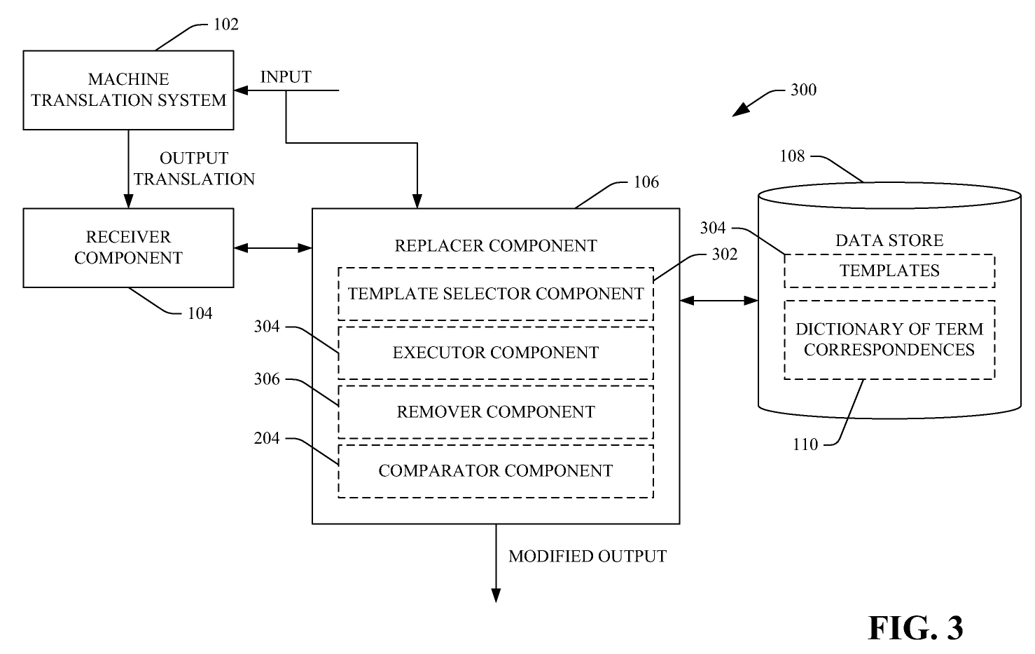

With reference now to FIG. 3, another example system 300 that facilitates replacing a term in an output translation from a machine translation system is illustrated. The system 300 includes the machine translation system 102 that receives input text or speech (in the source language). The machine translation system 102 translates the input text or speech to the target language to create a translation of the input text and/or speech. As noted above, the receiver component 104 can receive the output translation, and the replacer component 106 can be in communication with the receiver component 104.

The replacer component 106 can additionally be configured to receive the input text or speech, and can access the dictionary of term correspondences 110 in the data store 108 to determine whether any terms in the input text or speech reside in the dictionary of term correspondences 110. For instance, the replacer component 106 can determine that a first term in the input text or speech is included in the dictionary of term correspondences 110.

The replacer component 106 can include a template selector component 302, which can access the data store 108. More particularly, templates 304 can be retained in the data store 108, and the template selector component 302 can select one or more templates from the data store 108. A template can be a sentence or phrase in the source language, wherein the sentence or phrase includes one or more terms that are translated consistently between the source language and the target language. A template can be configured to receive a term that completes the sentence or phrase. An example of a template can be “I own ______”, where the terms “I” and “own” are consistently translated between the source language and the target language, and the template can be configured to receive a term in the input text or speech that is included in the dictionary 110 to complete the sentence or phrase. The templates 304 in the data store 108 can include a plurality of templates that include different words or phrases. Further, a term may be translated differently when different templates are used. For instance, a term in the source language may be translated in various ways in the target language depending on context. Thus, the term may be translated differently depending upon the template selected.

The replacer component 106 can also include an executor component 304 that places the first term in the input text or speech in a template selected by the template selector component (e.g., to complete a phrase or sentence). The executor component 304 can output the template that includes the first term, and the machine translation system 102 can translate the template (which includes the first term).

The replacer component 106 can additionally include a remover component 306 that removes portions of the translation of the template (which includes the first term) output by the machine translation system 102. For instance, as noted above, terms in the template (prior to receiving the first term) in the source language can be consistently translated to the target language (e.g., each time terms in the template are translated from the source language to the target language, they are translated consistently regardless of context). Accordingly, consistently translated terms in the template can be located and removed, and thus a translation of the first term in the target language can be ascertained by way of inference/deduction.

The replacer component 106 may also include the comparator component 204, which can compare the first term in the target language determined by way of inference/deduction with the translation of the input text or speech in the target language. Thus, the comparator component 204 can locate a translation of the first term in the translation of the input text or speech (e.g., in the target language). The replacer component 106 can thereafter replace a term in the translation of the input text or speech with a term from the dictionary of term correspondences 110. If the comparator component 106 does not locate the translation of the first term in the translation of the input text or speech, the template selector component 302 can select another template from the templates 304 in the data store 108, and the process can be iterated until a desired translation is found.

An example is provided herein to illustrate operability of the system 300. The dictionary of term correspondences 110 can indicate that the English (e.g., the source language) term “screen” is desirably translated to XXX in a target language. The input text and/or speech received by the machine translation system 102 can include the sentence “My computer screen is broken”, and the machine translation system 102 can translate such sentence to AAA BBB CCC DDD EEE in the target language. At this point it can be assumed that a location of a translation of the term “screen” in the output sentence AAA BBB CCC DDD EEE is unknown.

The replacer component 106 can receive the input text and/or speech, and can access the dictionary of term correspondences 110. In this example, the replacer component 106 can ascertain that the term “screen” in the source language is desirably translated to XXX in the target language, and that the output translation does not include the term XXX. Accordingly, to replace a translation of the word “screen” with the term XXX, the translation of the term “screen” output by the machine translation system 102 is desirably located.

The template selector component 302 can select a first template from the templates 304 in the data store. For instance, the selected first template may be “I own a ______.” The executor component 306 can position the term “screen” in the template and output the template. Thus, the output template can be “I own a screen.” The machine translation system 102 can receive the first template output by the executor component 306 and can translate the first template to the target language. For instance, the first template (including the term “screen”) may be translated by the machine translation system 102 to the target language as MMM NNN OOO. The remover component 308 can receive the translated template. The terms “I” and “own a” in the source language may be consistently translated to NNN and OOO in the target language, respectively, and thus the remover component 308 can remove such terms. Thus, with respect to the first template, the remover component 308 can infer/deduce that the machine translation system 102 translates the term “screen” in the source language to “MMM” in the target language.

The comparator component 204 can compare the inferred/deduced term in the target language (MMM) with the translation of the input text or speech (AAA BBB CCC DDD EEE). In this example, comparator component 204 can output an indication that the translation of the input text or speech does not include the inferred/deduced term with respect to the first template.

The template selector component 302 can select a second template from the templates 304 in the data store 108 in response to the indication output by the comparator component 204. For instance, the second template can be “A ______ exists.”

The executor component can place the term “screen” in the second template and output the second template (including the term “screen”, such that the output second template is “A screen exists.” The machine translation system 102 can receive the output second template and can generate a translation for the second template, wherein the translation can be “CCC PPP Q.” The term “exists” may consistently translate from the source language to the target language as “PPP,” and the term “A” may consistently translate from the source language to the target language as “Q.” Accordingly, the remover component 308 can remove the terms “PPP” and “Q,” and thereby deduce/infer that the translation of the term “screen” with respect to the second template is “CCC.”

The comparator component 204 can compare the original output of the machine translation system 102 (AAA BBB CCC DDD EEE) with the inferred/deduced term (CCC). The comparator component 204 can thus determine that the machine translation system 102 translated the term “screen” to “CCC” in the translation of the input text or speech. The replacer component 106 can then replace the term “CCC” in the translation of the input text or speech with the term “XXX” as indicated in the dictionary of term correspondences 110.

While the above examples describe the template selector component 302, the executor component 306, and the remover component 308 being included in the replacer component 106 and executing at run-time of the machine translation system 102, it is to be understood that such components may not be included in the replacer component 106 and may execute prior to run-time of the machine translation system 102. For instance, prior to run-time, the template selector component 302 may select each template in the templates 304, and the executor component 306 can insert each term in the dictionary of term correspondences 110 into each of the templates. The machine translation system 102 can be employed to output translations for each of the templates that include each of the terms in the dictionary of term correspondences 110. The remover component 308 can be employed to determine through deduction/inference various translations of the terms in the dictionary of term correspondences 110. Thus, different translations for each of the terms in the dictionary of term correspondences 110 can be determined prior to run time. These translations can then be stored in the data store 108, in another data store, and/or distributed across several data stores. The comparator component 204 may access such translations when locating a translation for a term in the dictionary of term correspondences 110.

Moreover, the selector component 302, the executor component 306, and/or the remover component 308 can be configured to execute prior to run-time (e.g., for a subset of terms in the source language in the dictionary of term correspondences 110) and at run-time if needed.

Furthermore, the above example was provided for purposes of illustration only, and is not intended to be limiting as to form of a template, type of template that can be used, or type of term (e.g., noun, verb, adverb, . . . ) that can be identified through use of a template.

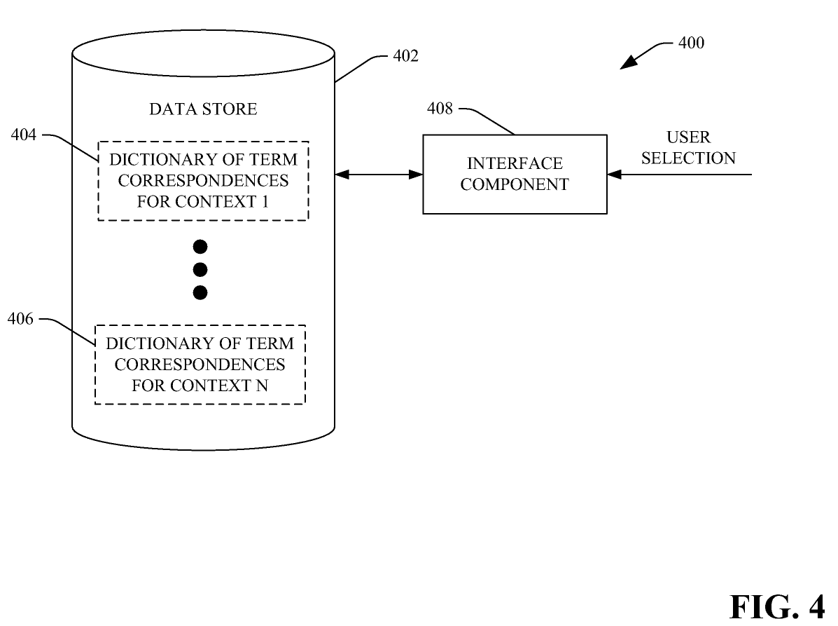

Now referring to FIG. 4, an example system 400 that facilitates enabling user selection of a particular dictionary of term correspondences for a particular context is illustrated. The system 400 includes a data store 402 that can retain data. The data store 402 may be a hard drive, a memory (such as RAM, ROM DRAM, SDRAM, etc.). Furthermore, the data store 402 can be accessible online (e.g., as a portion of a server) and/or retained on a computing device of a user of a machine translation system.

A plurality of dictionaries of term correspondences can be retained in the data store 402. For instance, a first dictionary of term correspondences 404 for a first context through an Nth dictionary of term correspondences 406 for an Nth context can be retained in the data store 402. The plurality of dictionaries of term correspondences can correspond to any suitable contexts. For instance, the first dictionary of term correspondences can correspond to an Information Technology (IT) context, a second dictionary of term correspondences can correspond to a legal context, a third dictionary of term correspondences can correspond to an automotive context, etc. One or more of the dictionaries of term correspondences 404-406 in the data store 402 can be defined by an operator of a machine translation system, such that a first-time user of the machine translation system can select a dictionary of term correspondences that corresponds to a context of translation desired by the user. In another example, the dictionaries may be created by and/or adapted by individual users and retained on their own computing devices or in an online data store.

The system 400 additionally includes an interface component 408 that can receive instructions from a user to select a particular dictionary of term correspondences (e.g., based upon a selected context), and the selected dictionary can be used in connection with a machine translation system to translate a document from a source language to a target language. For instance, the interface component 408 can be a port, a pointing and clicking device, a touch-sensitive screen, a software application that facilitates selection of a particular dictionary of term correspondences, etc.

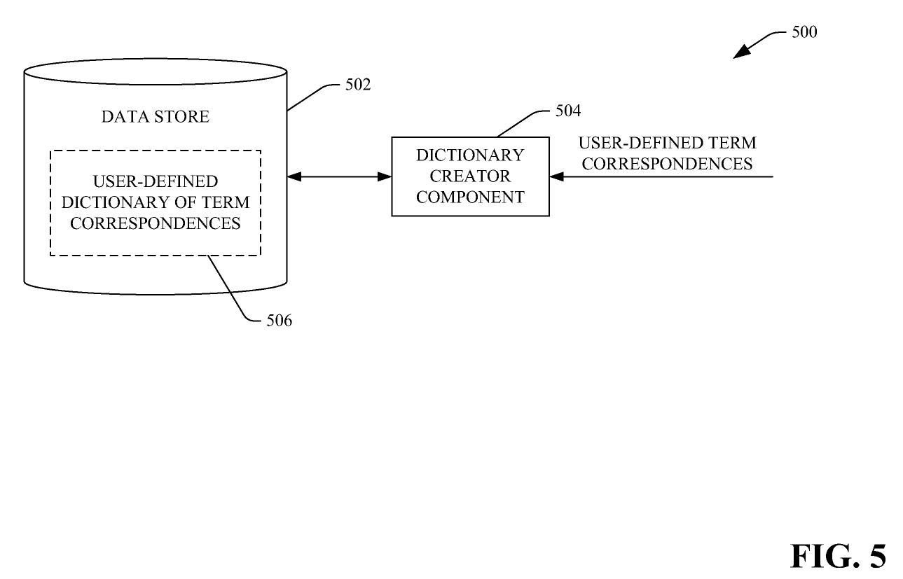

Referring now to FIG. 5, an example system 500 that facilitates user-creation of a dictionary of term correspondences is illustrated. The system 500 includes a data store 502, wherein the data store 502 can reside on a computing device of a user or at an online location (e.g., in a server accessible by way of the Internet).

The system 500 can further include a dictionary creator component 504, which can be employed to create a new dictionary of term correspondences and/or adapt an existing dictionary of term correspondences. In a first example, the dictionary creator component 504 can receive an instruction from a user to create a user-defined library of term correspondences 506 and store such dictionary of term correspondences 506 in the data store 502. The user can instruct the dictionary creator component 504 to assign a particular name or context to the dictionary of term correspondences 506 such that the user will be able to quickly ascertain context corresponding to the dictionary of term correspondences 506 (e.g., automotive, legal, IT, . . . ).

Furthermore, the dictionary creator component 504 can receive correspondences between terms in two languages, and such correspondences can be retained in the dictionary of term correspondences 506 in the data store 502. For instance, the user can indicate that term XXX in a source language is desirably translated to term YYY in a target language. When the machine translation system 102 (FIG. 1) is executed with the replacer component 106, the replacer component 106 can replace terms in the output translation with terms in the user-defined dictionary of term correspondences 506. In yet another example, the dictionary creator component 504 can receive instructions to modify contents of the user-defined dictionary of term correspondences 506.

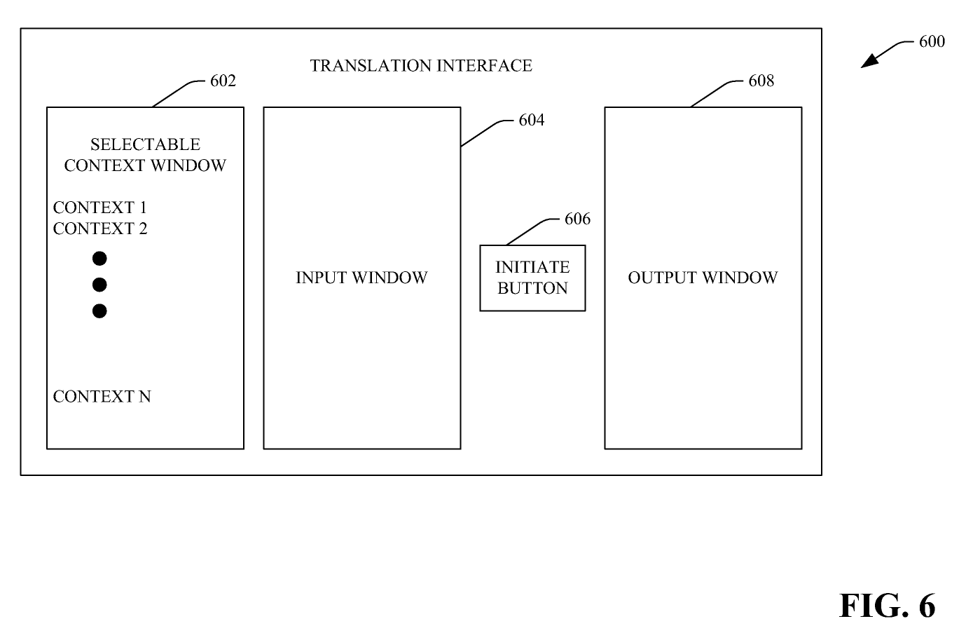

Now referring to FIG. 6, an example interface 600 that can be used in connection with a machine translation system is illustrated. The interface 600 can include a selectable context window 602, wherein a user can employ a mouse, keystrokes, or the like to select a particular context to use when translating text from a source language to a target language. For instance, a first context may pertain to a particular information technology product, a second context may pertain to a second information technology product, etc.

The interface 600 can further include an input window 604 that can facilitate receipt of input text that is desirably translated from a source language to a target language. For instance, the input window can be a field that facilitates receipt of text (e.g., typed, cut and pasted from another application, . . . ) in the source language. In another example, the input window 604 can facilitate receipt of text in a particular application or format.

Further, the interface 600 can include an initiate button 606 that can be selected by the user to translate text input by way of the input window 604 to the target language. As described above, the machine translation system 102 can output a translation, and such translation can be modified through use of a dictionary of term correspondences selected by the user (through use of a context selected in the selectable context window 602). An output window 608 can display the modified translation. In another example, the modified translation can be saved as a particular type of document (e.g., a word processing document, a spreadsheet document, . . . ).

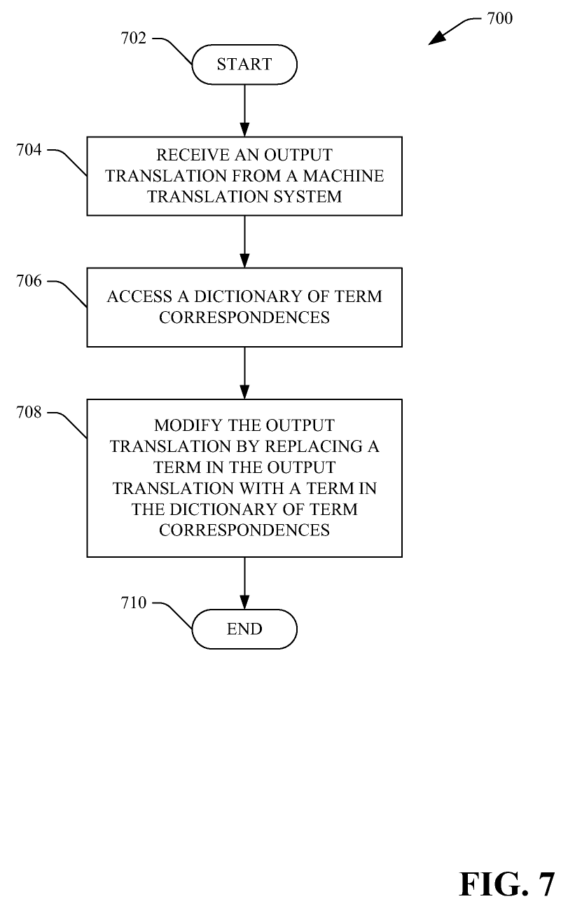

With reference now to FIGS. 7-11, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 7, a methodology 700 that facilitates modifying a translation of text or speech while considering context is illustrated. The methodology 700 starts at 702, and at 704 an output translation from a machine translation system is received. For instance, the machine translation system can receive input text or speech in a source language, can translate the input text or speech, and can output a translation of the input text or speech in a target language. The input text or speech can include a first term that corresponds to a second term in the translation output by the machine translation system. The first term is desirably translated to a third term in the target language (e.g., as defined in a dictionary of term correspondences). Depending on context, however, the machine translation system may translate the first term as the second term in the target language (and not as the desired third term).

At 706, a dictionary of term correspondences is accessed, wherein the dictionary of term correspondences can include an indication that the first term is desirably translated to the third term.

At 708, the output of the translation received at 704 is modified by replacing a term in the output translation with a term in the dictionary of term correspondences. For instance, the second term in the output translation can be replaced by the third term in the dictionary of term correspondences. The methodology 700 completes at 710.

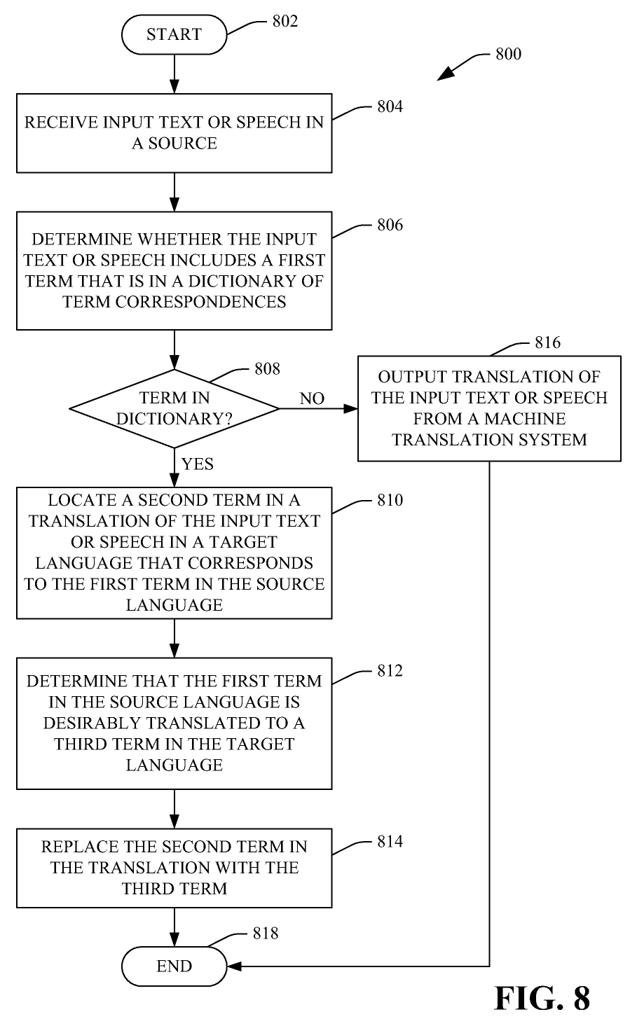

With reference now to FIG. 8, an example methodology 800 that facilitates replacing a term in a translation of input text or speech is illustrated. The methodology 800 starts at 802, and at 804 input text or speech in a source language is received. At 806, a determination regarding whether the input text or speech includes a first term that is in a dictionary of term correspondences is made. If it is determined at decision block 808 that the input text or speech includes the first term, at 810 a second term in a translation of the input text or speech (in a target language) that corresponds to the first term in the source language is located. The second term can be located through use of any suitable technique.

At 812, a determination is made that the first term in the source language desirably corresponds with a third term in the target language. In other words, it is determined that the first term is desirably translated to the third term. Such determination can be made by accessing and reviewing a dictionary of term correspondences. A modified translation of the input text or speech (modified to replace the second term with the third term) can be output to a user, stored in a data store, etc.

At 814, the second term in the translation is replaced with the third term. Thus the translation is modified such that first term in the source language is translated as the third term in the target language.

If at decision block 808 it is determined that the input text or speech does not include a term that is in the library of term correspondences, then at 816 the translation of the input text or speech is output to a user. The methodology 800 completes at 818.

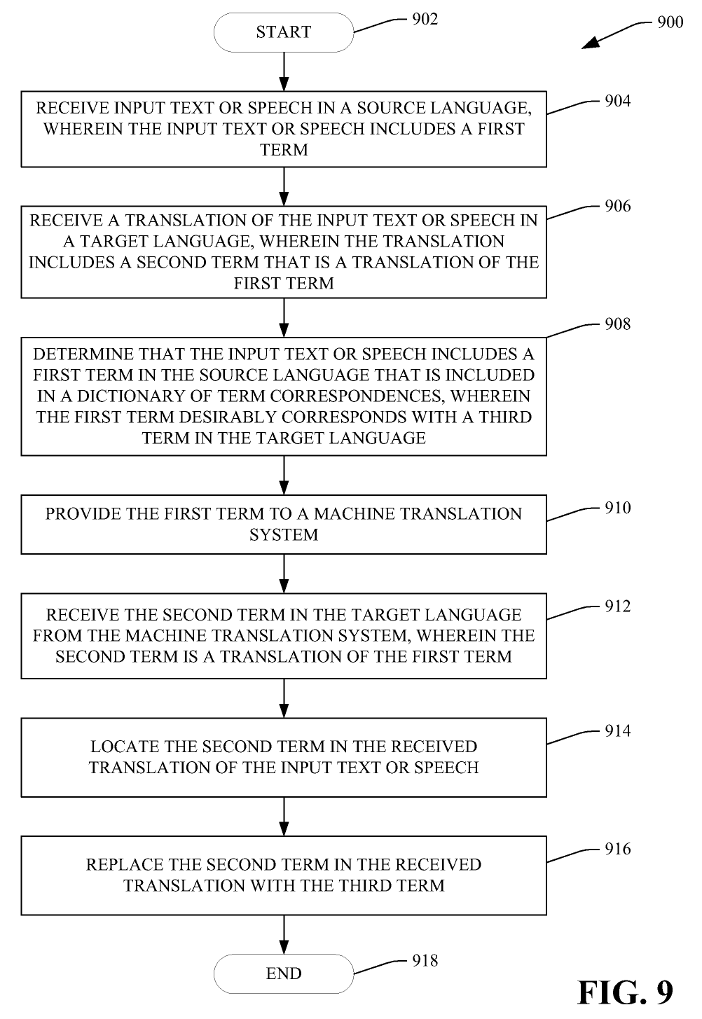

Turning now to FIG. 9, an example methodology 900 for modifying output of a machine translation system is illustrated. The methodology 900 starts at 902, and at 904 input text or speech is received in a source language, wherein the input text or speech includes a first term. At 906, a translation of the input text or speech is received in a target language, wherein the translation of the input text or speech includes a second term that is a translation of the first term.

At 908, a determination is made that the input text or speech includes the first term and that the first term exists in a dictionary of term correspondences, wherein the first term is desirably translated to a third term in the target language.

At 910, the first term is provided to a machine translation system. Pursuant to an example, the first term alone (and no other corresponding terms) can be provided to the machine translation system.

At 912, the second term in the target language is received from the machine translation system, wherein the second term is a translation of the first term. At 914, the second term is located in the translation of the input text or speech received at 906.

At 916, the second term in the translation of the input text or speech is replaced with the third term. Thus, the first term is translated as indicated in the library of term correspondences. The methodology 900 completes at 918.

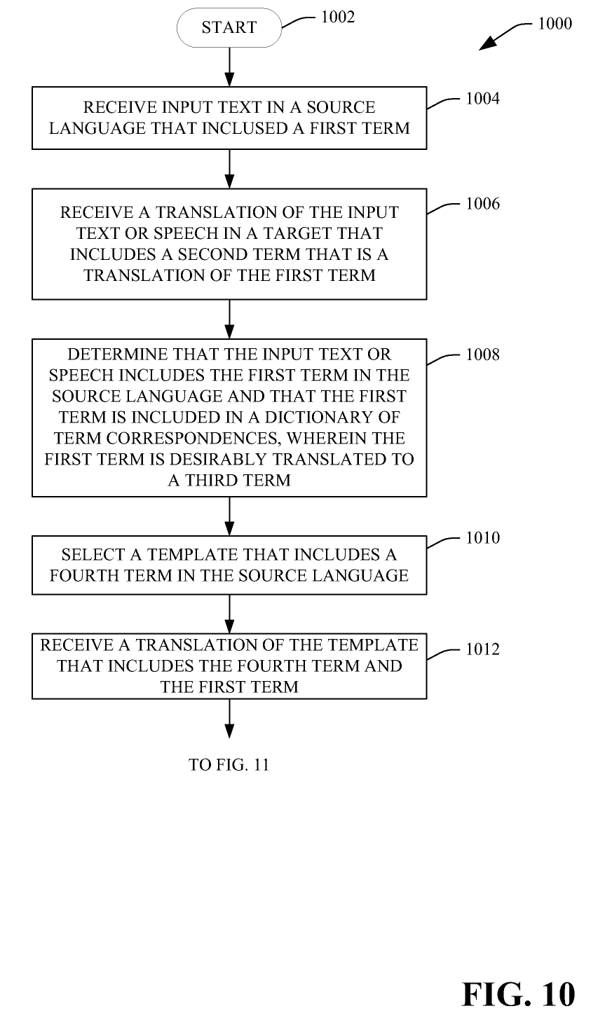

With reference now to FIG. 10, an example methodology 1000 for modifying an output translation is illustrated. The methodology 1000 starts at 1002, and at 1004 input text is received in a source language, wherein the input text includes a first term. At 1006, a translation of the input text is received in a target language, wherein the translation can be output by a machine translation system and includes a second term that is a translation of the first term.

At 1008, a determination is made that the input text includes the first term in the source language and that the first term exists in a dictionary of term correspondences, wherein the first term is desirably translated to a third term in the target language.

At 1010, a template that includes a fourth term in the source language is selected. For instance, the template can be configured to receive the first term such that the template includes the fourth term and the first term. In an example, the template can be a portion of a sentence or phrase, and the first term can be placed in the template to complete the sentence or phrase.

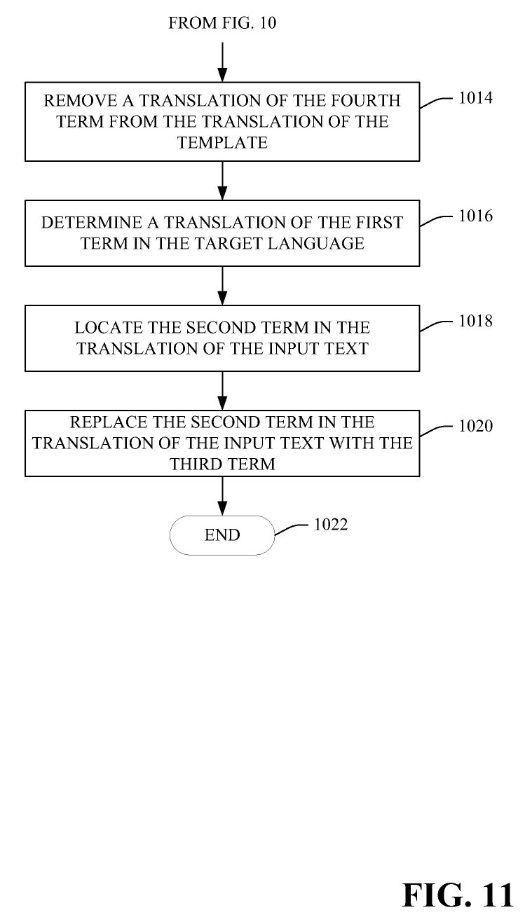

The methodology 1000 continues in FIG. 11, where at 1012 a translation of the template that includes the fourth term and the first term is received. At 1014, a translation of the fourth term can be removed from the translation of the template. For instance, the first term can be “the moon”, and the template can be “______ exists” (thus the fourth term can be “exists”). The first term can be placed in the template such that the template can be “the moon exists.” The translation of “exists” in the target language can be known, and such translation can be removed from the translated template.

At 1016, a translation of the first term in the target language is determined based at least in part upon removal of the translation of the fourth term from the translation of the template. In other words, the translation of the first term in the target language can be determined via inference/deduction.

At 1018, the translation of the first term in the translation of the input text is located (e.g., the second term is located). For instance, the translation of the first term determined via inference/deduction can be compared with the translation of the input text, such that the translation of the first term can be located in the input text.

At 1020, the second term in the translation of the input text is replaced with the third term. The methodology 1000 completes at 1022.

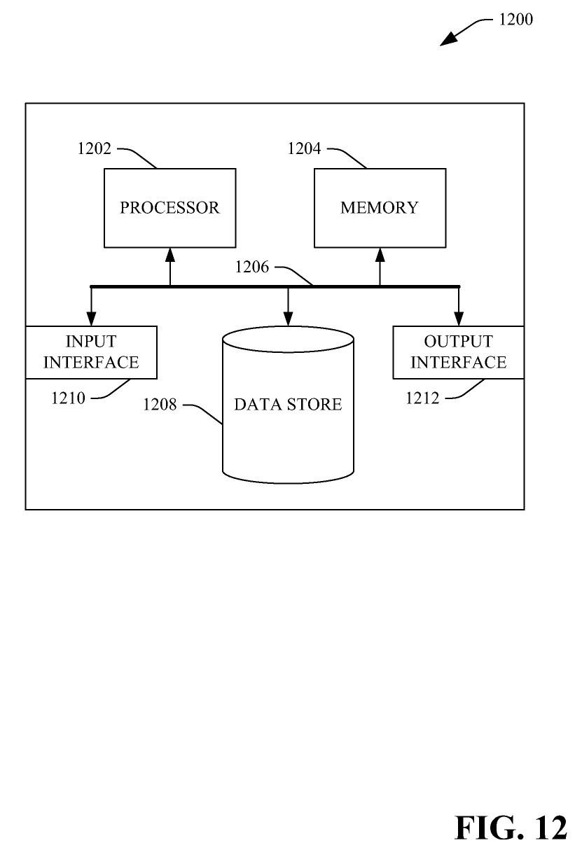

Now referring to FIG. 12, a high-level illustration of an example computing device 1200 that can be used in accordance with the systems and methodologies disclosed herein is illustrated. For instance, the computing device 1200 may be used in a system that supports machine translation. The computing device 1200 includes at least one processor 1202 that executes instructions that are stored in a memory 1204. The instructions may be, for instance, instructions for implementing functionality described as being carried out by one or more components discussed above or instructions for implementing one or more of the methods described above. The processor 1202 may access the memory 1204 by way of a system bus 1206. In addition to storing executable instructions, the memory 1204 may also store libraries of term correspondences, translation rules, information pertaining to various languages, etc.

The computing device 1200 additionally includes a data store 1208 that is accessible by the processor 1202 by way of the system bus 1206. The data store 1208 may include executable instructions, libraries of term correspondences, information pertaining to different natural languages, etc. The computing device 1200 also includes an input interface 1210 that allows external devices to communicate with the computing device 1200. For instance, the input interface 1210 may be used to receive instructions from an external computer device, input text or speech, etc. The computing device 1200 also includes an output interface 1212 that interfaces the computing device 1200 with one or more external devices. For example, the computing device 1200 may display text, images, etc. by way of the output interface 1212.

Additionally, while illustrated as a single system, it is to be understood that the computing device 1200 may be a distributed system. Thus, for instance, several devices may be in communication by way of a network connection and may collectively perform tasks described as being performed by the computing device 1200.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A system comprising the following computer-executable components:
a receiver component that receives an output translation from a machine translation system, wherein the output translation is in a target language and is based at least in part upon an input to the machine translation system in a source language, and wherein the input to the machine translation system includes a first term in the source language and the output translation includes a second term in the target language that corresponds to the first term; and
a replacer component in communication with the receiver component that accesses a dictionary of term correspondences, wherein the dictionary of term correspondences includes an indication that the input first term in the source language is desirably translated to a third term in the target language, and wherein the replacer component is configured to automatically replace the second term with the third term to modify the output translation.

2. The system of claim 1, wherein the machine translation system is one of a statistical machine translation system or a rules-based machine translation system.

3. The system of claim 1, further comprising a data store that retains the dictionary of term correspondences, wherein the data store resides on a personal computing device.

4. The system of claim 1, wherein at least one correspondence between two terms in the dictionary of term correspondences is user-defined.

5. The system of claim 1, further comprising a term locator component that is configured to perform the following acts:
receive the input to the machine translation system;
access the dictionary of term correspondences;
compare the input to the machine translation system with terms in the dictionary of term correspondences; and
output the first term to the machine translation system, wherein the machine translation system is configured to translate the first term to the second term.

6. The system of claim 5, further comprising a comparator component that receives the second term from the machine translation system and also receives the output translation and compares the second term and the output translation and locates the second term in the output translation, wherein the replacer component is configured to modify the output translation by replacing the second term in the output translation with the third term.

7. The system of claim 1, further comprising:
a template selector component that selects a template, wherein the template is a portion of a sentence or phrase in the source language and includes one or more terms that are translated consistently between the source language and the target language; and
an executor component that places the second term in the input text or speech in the template selected by the template selector component such that the template includes the second term, and wherein the machine translation system translates the template that includes the second term.

8. The system of claim 7, wherein the first term, the second term, and the third term are nouns.

9. The system of claim 7, further comprising a remover component that removes a portion of the translation of the template that includes the second term output by the machine translation system that does not correspond to the second term.

10. The system of claim 9, further comprising a comparator component that determines the second term by comparing the translation of the template that includes the second term output by the machine translation system with the output of the machine translation system.

11. The system of claim 1, further comprising an interface component that receives instructions from a user to select the dictionary of term correspondences from amongst a plurality of dictionaries of term correspondences, wherein the selected dictionary of term correspondences is used by the replacer component to modify the output translation by replacing the second term with the third term.

12. A method comprising the following computer-executable acts:
receiving text that is input to a machine translation system, wherein the received text is in a source language, wherein the received text includes a first term;
receiving an output translation of the received text from the machine translation system in a target language, wherein the output translation includes a second term that is a translation of the first term;
accessing a dictionary of term correspondences, wherein the dictionary of term correspondences includes an indication that the first term is desirably translated to a third term in the target language;
modifying the output translation by replacing the second term with the third term.

13. The method of claim 12, wherein the machine translation system is one of a statistical machine translation system or a rules-based machine translation system.

14. The method of claim 12, wherein the first term, the second term, and the third term are one of a noun or a verb.

15. The method of claim 12, further comprising comparing the received text that is input to the machine translation system with content of the dictionary of term correspondences to determine that the first term is desirably translated to the third term.

16. The method of claim 12, further comprising:
providing the first term alone to the machine translation system;
receiving from the machine translation system the second term as a translation of the first term;
locating the second term in the output translation; and
replacing the located second term with the third term in the output translation.

17. The method of claim 12, further comprising:
accessing a template, wherein the template includes a fourth term in the source language;
inserting the first term in the template, such that the template includes the fourth term and the first term;
translating the template that includes the fourth term and the first term to the target language to create a translated template;
removing a translation of the fourth term from the translated template; and
determining a translation of the first term in the target language.

18. The method of claim 17, further comprising:
comparing the translation of the first term in the target language with the output translation of the received text; and
determining that the translation of the first term in the target language is substantially similar to the second term in the output translation of the received text based at least in part upon the comparison.

19. The method of claim 1, wherein the translation of the first term in the target language is determined prior to run-time of the machine translation system.

20. A computer-readable medium comprising instructions that, when executed by a processor, perform the following acts:
receive input text in a source language, wherein the input text includes a first term;
receive a translation of the input text in a target language, wherein the translation of the input text includes a second term that is a translation of the first term;
determine that the input text includes the first term and that the first term is included in a dictionary of term correspondences, wherein the first term is desirably translated to a third term in the target language;
select a template that includes a fourth term in the source language, wherein the template is configured to receive the first term such that the template includes the fourth term and the first term;
receive a translation of the template that includes the fourth term and the first term;
remove a translation of the fourth term from the translation of the template;
determine a translation of the first term in the target language based at least in part upon removal of the translation of the fourth term from the translation of the template;
locate the translation of the first term in the translation of the input text; and
replace the second term in the translation of the input text with the third term.
